(19) United States
(12) Patent Application Publication
(10) Pub. No.: US 2020/0161694 A1
(43) Pub. Date: May 21, 2020

(54) ELECTRODE ASSEMBLY AND BATTERY HAVING THE SAME

(71) Applicant: NINGDE AMPEREX TECHNOLOGY LIMITED, Ningde (CN)

(72) Inventors: Hu Xu, Ningde (CN); Zuzhen Gong, Ningde (CN); Zhixian Li, Ningde (CN); Huabing Song, Ningde (CN)

(21) Appl. No.: 16/590,211

(22) Filed: Oct. 1, 2019

(30) Foreign Application Priority Data
Nov. 19, 2018 (CN) 201811376277.9

(51) Int. Cl. H01M 10/04; H01M 2/02; H01M 4/62; H01M 2/26; H01M 10/0587; H01M 10/0585

(52) U.S. Cl. CPC H01M 10/0431; H01M 2/0277; H01M 2/0285; H01M 10/0585; H01M 2/0212; H01M 2/266; H01M 10/0587; H01M 4/621

(57) ABSTRACT

The present application discloses an electrode assembly and a battery including the same. The battery includes an electrode assembly and a casing accommodating the electrode assembly. The electrode assembly is formed by winding or stacking a first electrode sheet and a second electrode sheet. A separator is disposed between the first electrode sheet and the second electrode sheet. The electrode assembly includes a first end portion, a second end portion, a first main plane, a second main plane, and a binding layer. The second end portion and the first end portion are arranged oppositely. The second main plane and the first main plane are arranged oppositely. The binding layer includes a first area arranged at the first end portion and a second area arranged at the first main plane, and the first area is connected to the second area.

### CROSS-REFERENCE TO RELATED APPLICATION

This application claims priority to and benefits of Chinese Patent Application Serial No. 201811376277.9, filed with China National Intellectual Property Administration on Nov. 19, 2018, the entire content of which is incorporated herein by reference.

### FIELD

The present application relates to a field of electrochemical devices, and more particularly to an electrode assembly and a battery having the same.

### BACKGROUND

At present, a conventional battery structure generally uses an adhesive layer to connect a cell with a package casing to prevent the cell from sliding relative to the package casing during the drop so as to prevent head and tail portions of the cell from colliding, which may otherwise result in deformation and hence a short circuit. A pull force generated during the drop acts on a single-sided anode area or on an uncoated aluminum foil of an outer layer of the cell, which will probably tear the aluminum foil. Additionally, in order to prevent the separator from folding during the drop, tapes are applied around the head and tail portions of the cell. But the tapes around the head and tail portions will also pull the aluminum foil, and hence have a high probability of tearing the aluminum foil. Many particles and burrs are produced after the aluminum foil is torn, and these particles and burrs probably pierce the separator, thereby leading to a short circuit between the aluminum foil and a copper foil or between a cathode and the copper foil, and eventually causing the cell to heat up and fail.

### SUMMARY

The present application aims to propose an electrode assembly and a battery including the electrode assembly, and the battery has an advantage of excellent safety performance.

The electrode assembly according to embodiments of the present application includes a first electrode sheet and a second electrode sheet spaced apart from each other. A separator is provided between the first electrode sheet and the second electrode sheet. The first electrode sheet and the second electrode sheet are wound or stacked to form the electrode assembly. The electrode assembly includes: a first end portion provided with a tab, a second end portion arranged opposite to the first end portion, a first main plane, a second main plane arranged opposite to the first main plane, and a binding layer. The binding layer includes a first area arranged at the first end portion, and a second area arranged at the first main plane, in which the first area is connected to the second area.

For the battery according to the present application, by providing the first area and the second area and connecting the first area with the second area, the adhesion of the second area to the battery is transferred to the first area during the drop of the battery. Therefore, the tear of the electrode assembly due to the drop, which may cause the failure of the battery, is avoided.

In some embodiments, a part of the first area is arranged at the first electrode sheet.

In some embodiments, the first area extends from the first electrode sheet.

In some embodiments, a part of the first area is arranged at the separator.

In some embodiments, the first area extends from the separator.

In some embodiments, the first area is provided with a through hole, and the tab passes through the through hole.

In some embodiments, the first area and the second area partially overlap.

In some embodiments, the first area includes a first binding unit and a second binding unit, in which the first binding unit and the second binding unit are respectively connected to the second area.

In some embodiments, a first surface of the first area close to the electrode assembly is provided with a first adhesive layer.

In some embodiments, a first surface of the second area close to the electrode assembly is provided with a second adhesive layer.

In some embodiments, the binding layer further includes a third area arranged at the second end portion and connected to the second area.

In some embodiments, the binding layer further includes a fourth area arranged at the second main plane and connected to the first area.

In some embodiments, the fourth area is connected to the third area.

In some embodiments, a first surface of the fourth area is provided with a third adhesive layer; and a second surface of the fourth area is provided with a fourth adhesive layer, wherein the first surface of the fourth area faces the electrode assembly, and the second surface of the fourth area faces away from the electrode assembly.

In some embodiments, the third adhesive layer has an adhesion force different from an adhesion force of the fourth adhesive layer.

The present application further discloses a battery that includes an electrode assembly described above and a casing accommodating the electrode assembly.

### BRIEF DESCRIPTION OF THE DRAWINGS

These and/or additional aspects and advantages of embodiments of the present application will become apparent and more readily appreciated from the following descriptions made with reference to the drawings, in which:

FIGS. 1-4 illustrate a front view, a rear view, a top view and a bottom view according to an embodiment of the present application, respectively.

FIG. 5 illustrates a front view according to another embodiment of the present application.

FIG. 6 illustrates a bottom view according to the embodiment shown in FIG. 5.

FIG. 7 illustrates a front view according to another embodiment of the present application.

FIG. 8 illustrates a rear view according to the embodiment shown in FIG. 7.

FIG. 9 illustrates a top view according to the embodiment shown in FIG. 7.

FIG. 10 illustrates a top view according to another embodiment of the present application.

FIG. 11 illustrates a top view according to another embodiment of the present application.

FIG. 12 illustrates a front view according to another embodiment of the present application.

FIG. 13 illustrates a front view according to another embodiment of the present application.

FIG. 14 illustrates a front view according to another embodiment of the present application.

FIG. 15 illustrates a separator structure according to an embodiment of the present application.

### DETAILED DESCRIPTION

Embodiments of the present application will be described in detail and examples of the embodiments will be illustrated in the drawings, where same or similar reference numerals are used to indicate same or similar elements or elements with same or similar functions. The embodiments described herein with reference to drawings are explanatory, and only used to generally understand the present application. The embodiments shall not be construed to limit the present application.

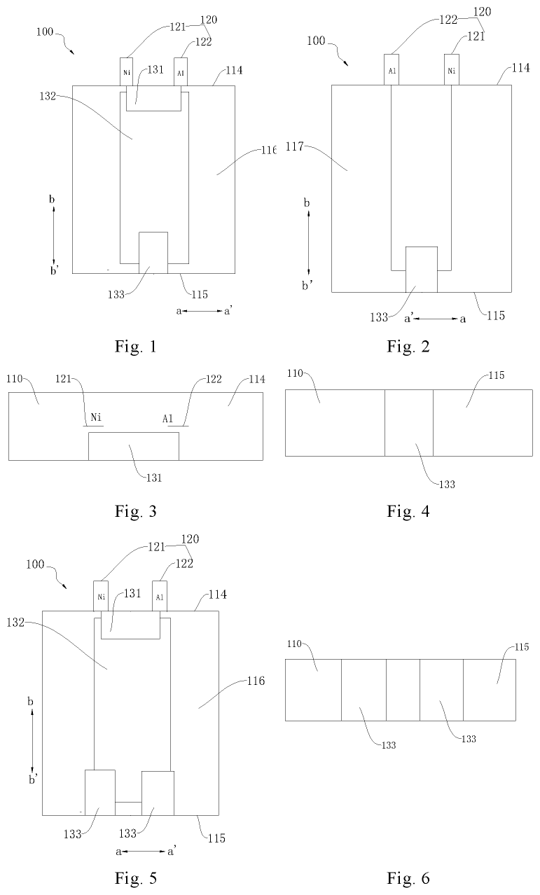

The electrode assemblies and batteries according to embodiments of the present application will be described with reference to FIGS. 1-15.

FIG. 1 illustrates a front view of an electrode assembly 100 according to an embodiment of the present application. In this embodiment, the electrode assembly 100 includes a first electrode sheet and a second electrode sheet spaced apart from each other, and a separator is disposed between the first electrode sheet and the second electrode sheet. The first electrode sheet and the second electrode sheet are wound or stacked to form the electrode assembly. The electrode assembly 100 includes a first end portion 114, a second end portion 115, a first main plane 116, a second main plane 117, and a binding layer. The second end portion 115 and the first end portion 114 are arranged oppositely, and the first main plane 116 and the second main plane 117 are arranged oppositely. The binding layer includes a first area 131 and a second area 132; the first area 131 is arranged at the first end portion 114 while the second area 132 is arranged at the first main plane 116; the first area 131 winds around the first end portion 114 to connect to the second area 132.

By providing the first area 131 and the second area 132 and connecting the first area 131 with the second area 132, adhesion of the second area 132 to the battery is transferred to the first area 131 during the drop of the battery, to avoid tearing the electrode assembly 100 due to the drop, which may otherwise cause failure of the battery.

According to another embodiment of the present application, a part of the first area 131 may also be arranged at the separator or the first electrode sheet. Therefore an external force received during the use of the electrode assembly can be partially transferred to an interior of the electrode assembly 100 through the first area 131 which is connected to the second area 132. Optionally, the first area 131 may extend from the separator or the first electrode sheet, such that an external force received by the first area 131 can also be partially transferred to the interior of the electrode assembly 100.

According to an embodiment of the present application, a first adhesive layer can be provided to a first surface of the first area 131 close to the electrode assembly 100, such that the first area 131 adheres to the electrode assembly 100. By providing a first surface of the second area 132 close to the electrode assembly 100 with a second adhesive layer, the second area 132 can adhere to the electrode assembly 100. The first area 131 and the second area 132 can be connected by means of the first adhesive layer or the second adhesive layer, as well. Certainly, according to another embodiment of the present application, the second area 132 may be an extension of the first area 131 on the first main plane 116 of the electrode assembly 100.

FIGS. 2-4 illustrate a rear view, a top view and a bottom view of the embodiment shown in FIG. 1, respectively. Referring to FIG. 3, a part of the first area 131 can be arranged at the separator or the first electrode sheet, or extend from the separator or the first electrode sheet, and be partially connected to the second area 132. Referring to FIGS. 1-4, the first area 131 and the second area 132 can be partially overlapped and be connected.

Referring to FIGS. 1-4, in the electrode assembly 100 according to an embodiment of the present application, the binding layer can further include a third area 133 arranged at the second end portion 115. The third area 133 has a first end arranged at the first main plane 116 and a second end arranged at the second main plane 117, that is, the third area 133 can be winded around the second end portion 115 to connect to the second area 132. Certainly, according to an embodiment of the present application, the third area 133 can be formed by extension of the separator or the first electrode sheet, and partially overlapped and connected to the second area 132.

In addition, the electrode assembly according to an embodiment of the present application can further include a tab 120 provided to the first end portion 114. The tab 120 can include a first tab 121 and a second tab 122, and the first tab 121 and the second tab 122 are both located at one side of the first end portion 114.

Referring to FIG. 1, in an a-a′ direction, the first area 131 may have a width smaller than a width of the second area 132, and the third area 133 may have a width smaller than the width of the second area 132. For example, the width of the third area 133 may be 11 mm.

According to another embodiment of the present application, in the a-a′ direction, the width of the first area 131 may be greater than the width of the second area 132, and the width of the third area 133 may be greater than the width of the second area 132.

FIG. 5 illustrates the electrode assembly 100 according to an embodiment of the present application. Different from the embodiment shown in FIG. 1, the binding layer includes two third areas 133 in this embodiment. The two third areas 133 are arranged in the a-a′ direction shown in FIG. 5. Each of the third region 133 is winded around the second end portion 115, and each third region 133 has a first end overlap with and connect to the second area 132. Moreover, in the a-a′ direction, each of the third region 133 may have a width smaller than the width of the second area 132. FIG. 6 shows a bottom view of the electrode assembly 100 according to the embodiment shown in FIG. 5, and illustrates two third areas 133.

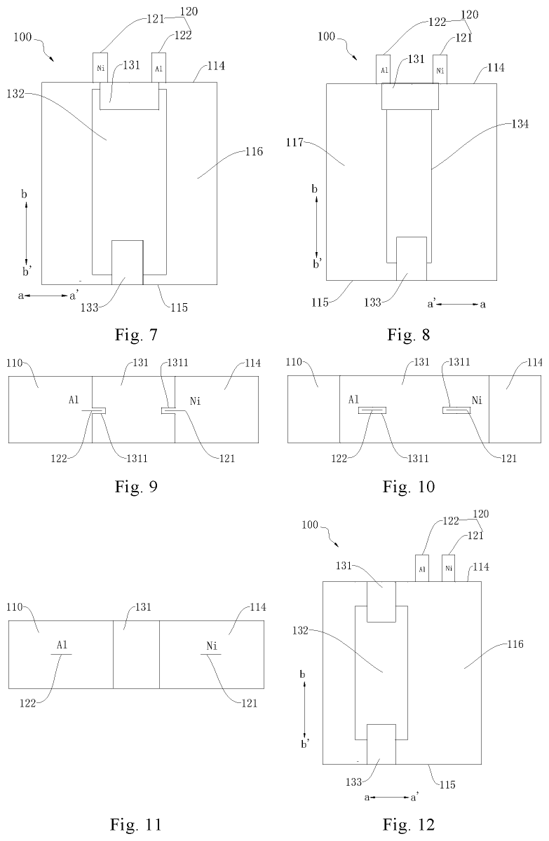

FIGS. 7-9 illustrate the electrode assembly 100 according to another embodiment of the present application. Different from the embodiment shown in FIG. 1, the binding layer further includes a fourth area 134; the fourth area 134 is arranged at the second main plane 117, and overlaps with and adheres to a part of the first area 131 and a part of the third area 133, respectively.

According to an embodiment of the present application, a third adhesive layer can be provided to a first surface of the fourth area 134 close to the electrode assembly 100, such that the fourth area 134 adheres to the electrode assembly 100. A fourth adhesive layer can be provided to a second surface of the fourth area 134 away from the electrode assembly 100, and the fourth adhesive layer can be used to make the electrode assembly 100 adhere to a casing that accommodates the electrode assembly 100. Certainly, according to another embodiment of the present application, the fourth area 134 may be an extension of the first area 131 on the second main plane 117 of the electrode assembly 100; the fourth area 134 may be an extension of the third area 133 on the second main plane 117 of the electrode assembly 100.

Referring to FIGS. 7-8, in the a-a′ direction, the width of the third area 133 may be smaller than a width of the fourth area 134, and the width of the first area 131 may be greater than the width of the fourth area 134. According to another embodiment of the present application, the width of the third area 133 may be greater than the width of the fourth area 134, and the width of the first area 131 may be smaller than the width of the fourth area 134.

Referring to FIG. 9, in order to facilitate the arrangement of the tab 120, the first area 131 can be provided with a through hole 1311. That is, when the width of the first area 131 is greater than a spacing between the tabs, the tab 120 can pass through the through hole 1311. The tab 120 can partially or completely pass through the through hole 1311, that is, the through hole 1311 may be an open or closed hole. FIG. 10 illustrates a case where the tab 120 completely passes through the through hole 1311. Thus, the structure described above is applicable to a battery with a narrow spacing between the two tabs 120. Moreover, the operation is simple. Further, a tape is eliminated. And the energy density loss is little.

FIG. 11 illustrates another embodiment of the present application. According to FIG. 11, when the spacing between the tabs is relatively wide, the first area 131 can be arranged between the first tab 121 and the second tab 122, that is, orthographic projections of the first tab 121, the second tab 122 and the second area 132 on the first main plane 116 do not overlap.

FIG. 12 illustrates another embodiment of the present application. According to FIG. 12, when the spacing between the tabs is relatively narrow, the first tab 121 and the second tab 122 can be arranged at the same side of the first area 131.

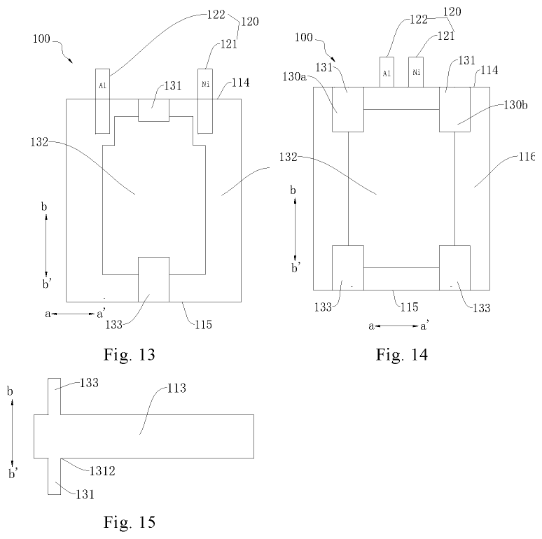

FIG. 13 illustrates the electrode assembly 100 according to another embodiment of the present application. In this embodiment, the second area 132 exhibits an irregular pattern (or abnormally shaped), which can be made by cutting a rectangular sheet. For example, the second area 132 is constructed by cutting a right angle of the rectangular sheet, and the orthographic projections of the first tab 121, the second tab 122 and the second area 132 on the first main plane 116 do not overlap, thereby reducing an overall thickness of the battery.

FIG. 14 illustrates the electrode assembly 100 according to another embodiment of the present application. In this embodiment, the first area 131 can include a first binding unit 130a and a second binding unit 130b, and the first binding unit 130a and the second binding unit 130b connect to the second area 132, respectively. The first binding unit 130a and the second binding unit 130b can be arranged at two sides of the tab 120; or at least one of the first binding unit 130a and the second binding unit 130b can be arranged between the first tab 121 and the second tab 122.

Reference throughout this specification to “an embodiment,” “some embodiments,” “an exemplary embodiment,” “an example,” “a specific example,” or “some examples,” means that a particular feature, structure, material, or characteristic described in connection with the embodiment or example is included in at least one embodiment or example of the present application. Thus, the appearances of the above phrases throughout this specification do not necessarily refer to the same embodiment or example. Furthermore, the particular features, structures, materials, or characteristics may be combined in any suitable manner in one or more embodiments or examples.

Although embodiments of the present application have been shown and described, it would be appreciated by those skilled in the art that various changes, modifications, alternatives and variations can be made to the embodiments of the present application without departing from the principle and purpose of the present application. The scope of the present application is defined by the claims or the like.

What is claimed is:

1. An electrode assembly, comprising a first electrode sheet, a second electrode sheet, and a separator disposed there between, wherein the first electrode sheet and the second electrode sheet are wound or stacked to form the electrode assembly,
wherein the electrode assembly comprises:
a first end portion provided with a tab,
a second end portion arranged opposite to the first end portion,
a first main plane,
a second main plane arranged opposite to the first main plane, and
a binding layer comprising:
a first area arranged at the first end portion, and
a second area arranged at the first main plane,
wherein the first area is connected to the second area.

2. The electrode assembly according to claim 1, wherein a part of the first area is arranged at the separator or the first electrode sheet.

3. The electrode assembly according to claim 2, wherein the first area extends from the first electrode sheet or the separator.

4. The electrode assembly according to claim 1, wherein the first area is provided with a through hole, and the tab passes through the through hole.

5. The electrode assembly according to claim 1, wherein the first area and the second area partially overlap.

6. The electrode assembly according to claim 1, wherein the first area comprises a first binding unit and a second binding unit, and the first binding unit and the second binding unit are respectively connected to the second area.

7. The electrode assembly according to claim 1, wherein a first surface of the first area close to the electrode assembly is provided with a first adhesive layer.

8. The electrode assembly according to claim 1, wherein a first surface of the second area close to the electrode assembly is provided with a second adhesive layer.

9. The electrode assembly according to claim 1, wherein the binding layer further comprises a third area arranged at the second end portion and connected to the second area.

10. The electrode assembly according to claim 9, wherein the binding layer further comprises a fourth area arranged at the second main plane and connected to the first area.

11. The electrode assembly according to claim 10, wherein the fourth area is connected to the third area.

12. The electrode assembly according to claim 11, wherein a first surface of the fourth area is provided with a third adhesive layer; and a second surface of the fourth area is provided with a fourth adhesive layer;
wherein the first surface of the fourth area faces the electrode assembly, and the second surface of the fourth area faces away from the electrode assembly.

13. The electrode assembly according to claim 12, wherein the third adhesive layer has an adhesion force different from an adhesion force of the fourth adhesive layer.

14. A battery, comprising:
an electrode assembly comprising a first electrode sheet, a second electrode sheet, and a separator disposed there between, wherein the first electrode sheet and the second electrode sheet are wound or stacked to form the electrode assembly,
wherein the electrode assembly comprises:
a first end portion provided with a tab,
a second end portion arranged opposite to the first end portion,
a first main plane,
a second main plane arranged opposite to the first main plane, and
a binding layer comprising:
a first area arranged at the first end portion, and
a second area arranged at the first main plane,
wherein the first area is connected to the second area,
and a casing accommodating the electrode assembly.

15. The battery according to claim 14, wherein a part of the first area is arranged at the separator or the first electrode sheet.

16. The battery according to claim 15, wherein the first area extends from the first electrode sheet or the separator.

17. The battery according to claim 14, wherein the first area is provided with a through hole, and the tab passes through the through hole.

18. The battery according to claim 14, wherein the first area and the second area partially overlap.

19. The battery according to claim 14, wherein the first area comprises a first binding unit and a second binding unit, and the first binding unit and the second binding unit are each respectively connected to the second area.

20. The battery according to claim 14, wherein a first surface of the first area close to the electrode assembly is provided with a first adhesive layer.
